(19) United States
(12) Patent Application Publication
(10) Pub. No.: US 2007/0010959 A1
(43) Pub. Date: Jan. 11, 2007

(54) SYSTEM AND METHOD FOR ERROR COMPENSATION OF A COORDINATE MEASUREMENT MACHINE

(75) Inventors: CHIH-KUANG CHANG, TU CHENG (TW); Hua-Wei Yang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,638

(22) Filed: Apr. 15, 2006

(30) Foreign Application Priority Data
Jul. 8, 2005 (CN) 200510035936.9

(51) Int. Cl. G06F 19/00; G01P 21/00

(52) U.S. Cl. 702/94

(57) ABSTRACT

A method for error compensation of a Coordinate Measurement Machine (CMM) includes the steps of: setting a mathematical mode; detecting errors of the CMM; compensating the errors; measuring a standard object on the CMM and obtaining measured values; calculating the deviation of the measured values and compensation factors of each axis; comparing the deviation of the measured values with corresponding precision standard and determining whether the precision of the CMM is acceptable. A related method is also disclosed. By utilizing the present invention, the error compensation can be achieved quickly, and measurement accuracy is improved.

### FIELD OF THE INVENTION

The present invention is generally related to a system and method for error compensation of a Coordinate Measurement Machine (CMM).

### DESCRIPTION OF RELATED ART

With the advent of numerically controlled machine tools, the demand has grown for a means to support these equipments with a faster first-piece inspection and, in many cases, a 100% dimensional inspection. To satisfy this demand, the coordinate measurement machine (CMM) was developed in the early 1960's. A CMM can also be used as a layout machine before machining and for checking featured attributes after machining. In many cases, the CMM plays a vital role in the mechanization of the inspection process. It is used for measuring objects in a space in terms of their X, Y, and Z coordinates commonly referred as the length, the width, and the height respectively. The CMM probe is attached to an articulated arm and moved to a plurality of positions defined by the manufactured products or workpieces so to generate a plurality of Cartesian coordinate data points. The CMM collects and reports the measurement data by placing the tip of the calibrated probe into direct contact with a touch point, such as a surface or edge of the product or workpiece to be measured. The CMM records the location of multiple touch points and generates a database reflecting the dimensional geometric features of the workpiece.

Although the measurement data of the CMM is more accurate than other measuring machine, the CMM may have errors. The errors may be due to errors during measurement, environment factors, errors in the products or workpieces, errors of the CMM, or manual errors. In order for the CMM to operate properly, the accuracy of the CMM is important. Machines of the CMM can be calibrated, but the time of machine calibration is slow, and the effect of the adjustment may be insignificant.

What is needed, therefore, is a system and method for error compensation of a CMM.

### SUMMARY OF INVENTION

A system for error compensation of a Coordinate Measurement Machine (CMM) in accordance with a preferred embodiment includes an input/output module, a calculating module and a storing module. The input/output module is used for gathering particular data and outputting error compensation results. The calculating module is used for calculating error compensation of the CMM and generating a compensation document according to the compensation results. The storing module is used for saving the compensation document.

A method for error compensation of the CMM includes the steps of: setting a mathematical mode that includes mathematical functions and equations; detecting errors of the CMM and obtaining coordinate values of the errors; compensating the coordinate values of all the errors; measuring a standard object on the CMM and obtaining measured values; calculating the deviation of the measured values and compensation factors of each axis by utilizing the measured values according to the mathematical functions and equations; and comparing the deviation of the measured values with corresponding precision standard of the CMM that is provided by the CMM's manufacturer and determining whether the precision of the CMM is acceptable.

Other systems, methods, features, and advantages of the present invention will be or become apparent to one with skill in the art upon examination of the following drawings and detailed description.

### BRIEF DESCRIPTION OF DRAWINGS

FIG. 1 is a hardware configuration schematic diagram of a system for error compensation of a Coordinate Measurement Machine (CMM) in accordance with one embodiment;

FIG. 2 is a schematic diagram of software function modules of a computer of the system shown in FIG. 1;

FIG. 3 is a flowchart of a method for error compensation of a CMM;

FIG. 4 is a flowchart of one step of FIG. 3 in detail, namely for the errors compensating; and

FIG. 5 is a flowchart of returning coordinate values before error compensation.

### DETAILED DESCRIPTION

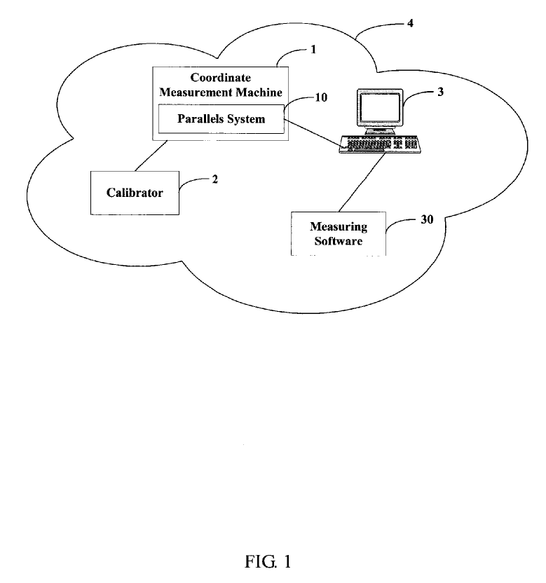

FIG. 1 is a hardware configuration schematic diagram of a system for error compensation of a Coordinate Measurement Machine (CMM) (hereinafter, “the system 4”), in accordance with one preferred embodiment. The hardware configuration of the system 4 typically includes a CMM 1, a calibrator 2, and at least one computer 3. The CMM 1 includes a parallel system 10 that is a device of the CMM 1 that tends to have machining errors. The calibrator 2 can be a laser interferometer that is used for detecting errors of the CMM 1. The errors may be, but not limited to, positional errors, straightness errors, and angular errors. The straightness errors are generated when the parallel system 10 runs along one axis, errors occur in the other axes. For example, when the parallel system 10 runs along X-axis, straightness errors may be generated in the Y-axis and Z-axis. The computer 3 is used for providing an operating interface for error compensation. The computer 3 may be installed with a measuring software 30, which is used for measuring a standard object on the CMM 1 and obtaining measured values of the component. For example, the standard object may be a measuring block.

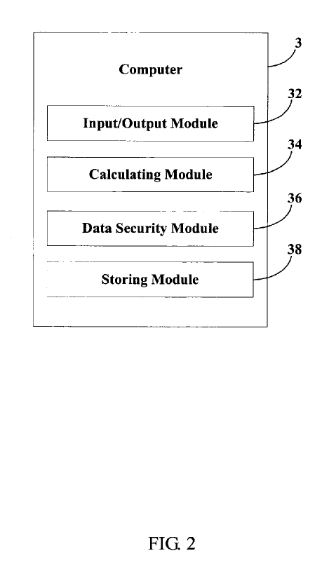

FIG. 2 is a schematic diagram of software function modules of the computer 3. The computer 3 mainly includes an input/output module 32, a calculating module 34, a data security module 36, and a storing module 38.

The input/output module 32 is used for gathering particular data and outputting error compensation results. The particular data may include original errors and/or linear coefficient related data. The original errors are errors of the CMM 1 that is detected by the calibrator 2. The original errors include positional errors, straightness errors, or angular errors. The linear coefficient related data are measured values of the standard object.

The calculating module 34 is used for calculating error compensation of the CMM 1. The calculating module 34 is further used for calculating the coordinate values before error compensation. The error compensation calculation includes individual error calculations, squareness error calculations, or total error calculations. The individual errors are calculated by utilizing a method of linear interpolation. The individual errors include positional errors, vertical straightness errors, horizontal straightness errors, rotational errors, yawing errors, or pitching errors on each axis (i.e., X-axis, Y-axis and Z-axis). The squareness errors are calculated by utilizing a method of minimum square and fitting function of a beeline. The total error is a summation of the individual errors and squareness errors. For example, if the coordinate value of the X-axis represented by X, the coordinate value of the Y-axis represented by Y, the coordinate value of the Z-axis represented by Z, the positional value of the X-axis represented by Dₓₓ, the straightness errors of the X-axis represented by D_{xy} and D_{xz} respectively, the rotational error of the X-axis represented by Rₓₓ, the yawing error of the X-axis represented by R_{xy}, the pitching error of the X-axis represented by R_{xz}, the squareness errors represented by S_{xy} and S_{zx} respectively, and the total error of the X-axis is calculated by using the following formula of
ΔX=D_{yx}−Dₓₓ+D_{zx}−Y*S_{xy}−Z*S_{zx}+R_{xz}+Z*(R_{yy}−R_{xy})
. Moreover, the calculating module 34 is also used for calculating the deviation of the measured values of the standard object and a compensation factor for each axis, comparing the deviation of the measured values with corresponding precision standard of the CMM 1 generated by the manufacture of CMM 1, and generating a compensation document according to the comparative result. The compensation factor equals to a corresponding real value divided-by a measured value of the standard object.

The data security module 36 is used for ensuring the compensation document's security by encrypting the compensation document with data streams of a binary system. The compensation document is generated during measurement and calculation. The data security module 36 is further used for decrypting the compensation document. That is, the data security module 36 can be used for setting the encrypting parameters and for encrypting or decrypting the data of the compensation document. The encrypting parameter settings include a secret key setting, a utilization vectors setting, an encryption method setting, and an encryption calculation setting. The encryption calculation is a symmetric algorithm. When the compensation document needs to be encrypted, firstly, the data security module 36 converts the compensation document into document flows, then it converts the document flows into encryption flows, finally it converts the encryption flows into data streams of the binary system. When the data security module 36 decrypts the compensation document, the calculation method is analogous to the encryption calculation. The storing module 38 is used for saving the compensation document and all the parameters.

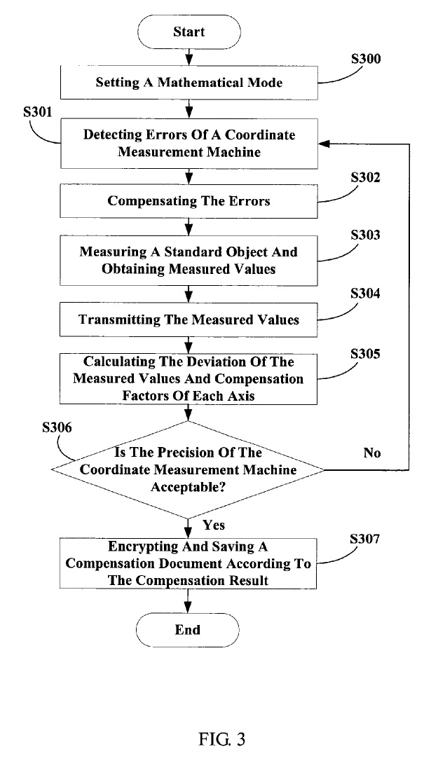

FIG. 3 is a flowchart of a method for error compensation of the CMM 1. In step S300, a user sets a mathematical mode using a mathematical method. The mathematical mode includes some mathematical functions and equations. The mathematical functions and equations are used for showing the correlations of all errors and for calculating error compensation. In step S301, the calibrator 2 detects errors of the CMM 1; these errors may include positional errors, straightness errors, and/or angular errors. In step S302, the calculating module 34 calculates the total error, and compensates the corresponding coordinate values with each error. In step S303, the measuring software 30 measures the standard object on the CMM 1 and obtains the measured values of the standard object. The standard object may be a measuring block. In step S304, the measured values are transmitted into the input/output module 32. In step S305, the calculating module 34 calculates the deviations of the measured values and the compensation factor of each axis. The deviation of one measured value of the standard object equals to the difference between the real value of the standard object and the corresponding measured value. The compensation factors include a factor of positional errors of a raster ruler, and/or factors of squareness errors between axes. For example, the factor of squareness errors is XY, YZ, or ZX. In step S306, the calculating module 34 compares the deviations of the measured values of the standard object with corresponding precision standard of the CMM 1 provided by the manufacturer of CMM 1, in order to determine whether the precision of the CMM 1 is acceptable. If the deviations of the measured values are within precision standards, the precision of the CMM 1 is acceptable, otherwise, the precision of the CMM 1 is unacceptable, the procedure returns to step S301. Once a precision is accepted, the calculating module 34 generates the compensation document according to the comparative result. In step S307, the data security 34 encrypts the compensation document, and the storing module 38 saves the compensation document.

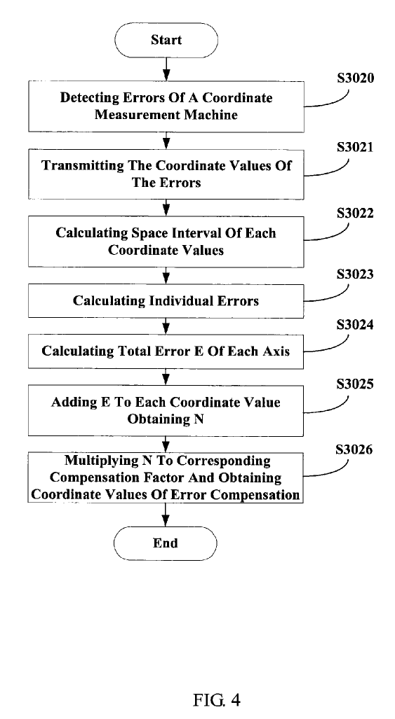

FIG. 4 is a flowchart of step S302 of FIG. 3 in detail, namely for the errors compensating. In step S3020, the calibrator 2 detects the errors of the CMM 1. In step S3021, the coordinate values of all the errors are transmitted into the input/output module 32. In step S3022, the calculating module 34 calculates the dimensions of each coordinate value. In step S3023, the calculating module 34 calculates the individual errors by utilizing a method of linear interpolation. For example, if the dimension between the coordinate values 30 and 60 is 30, the deviation is 0.03 at the point 30, and the deviation is 0.05 at the point 60, then the deviation at the point 40 is the result of:
W=(0.05−0.03)/30*(40−30)+0.03
. The individual errors include positional errors, vertical straightness errors, horizontal straightness errors, rotational errors, yawing errors and/or pitching errors of each axis (X-axis, Y-axis and Z-axis). In step S3024, the calculating module 34 calculates the total error E of each axis. In step S3025, the calculating module 34 adds E to each coordinate value and gets a numerical value N respectively. In step S3026, the calculating module 34 multiplies the compensation factor of each axis by corresponding N in order to get the coordinate values of error compensation.

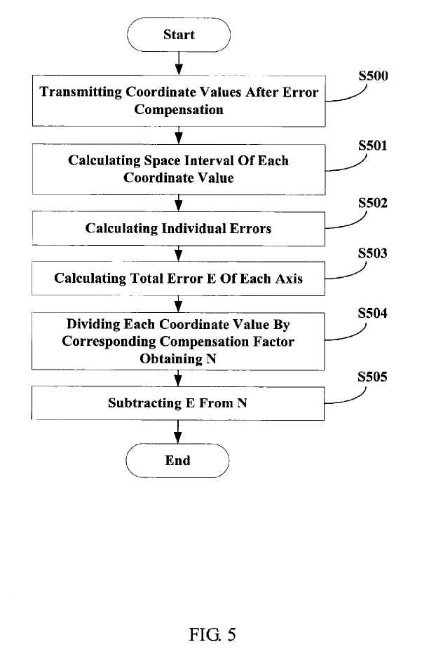

FIG. 5 is a flowchart of returning coordinate values before error compensation. The coordinate values before error compensation calculation are used for running of the CMM 1, and calculated by utilizing the method of repeat approximation. For example, if the original coordinate value is 100, and the coordinate value after error compensation is 100.1, then the coordinate value that returns the coordinate value before error compensation must be 100. step S500, the coordinate values after error compensation are transmitted into the input/output module 32. In step S501, the calculating module 34 calculates the dimensions of each coordinate value. In step S502, the calculating module 34 calculates the individual errors by utilizing the method of linear interpolation. In step S503, the calculating module 34 calculates the total error E of each axis. In step S504, the calculating module 34 divides each coordinate value by corresponding compensation factor and obtains N. In step S505, the calculating module 34 subtracts E from N and obtains the coordinate values before error compensation.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for error compensation of a Coordinate Measurement Machine (CMM), the system comprising:
an input/output module for gathering particular data and outputting error compensation results;
a calculating module for calculating error compensation of the CMM and generating a compensation document according to the compensation results; and
a storing module for saving the compensation document.

2. The system according to claim 1, further comprising a data security module for ensuring the security of the compensation results by encrypting the compensation document with data streams of a binary system.

3. The system according to claim 1, wherein the particular data comprise original errors and/or linear coefficient.

4. The system according to claim 1, wherein the error compensation calculation comprises an individual error calculation, an squareness error calculation, and/or a total error calculation.

5. A method for error compensation of a Coordinate Measurement Machine (CMM), the method comprising the steps of:
setting a mathematical mode that comprises mathematical functions and equations;
detecting errors of the CMM and obtaining coordinate values of the errors;
compensating the coordinate values of all the errors;
measuring a standard object on the CMM and obtaining measured values;
calculating the deviation of the measured values and compensation factors of each axis by utilizing the measured values according to the mathematical functions and equations; and
comparing the deviation of the measured values with corresponding precision standard of the CMM provided by the manufacturer of CMM and determining whether the precision of the CMM is acceptable.

6. The method according to claim 5, wherein the deviation of the measured value equals to the difference between the real value of the standard object and the corresponding measured value.

7. The method according to claim 6, wherein the compensation factor equals to a corresponding real value divided by a measured value of the standard object.

8. The method according to claim 5, wherein the step of compensating the coordinate values of all the errors comprising the steps of:
detecting the errors of the CMM;
calculating the space interval of each coordinate value;
calculating individual errors and squareness errors of all axes;
calculating the total error of each axis;
adding the total error to corresponding coordinate value and getting a numerical value; and
multiplying the numerical value by corresponding compensation factor and obtaining a coordinate value of error compensation.

9. The method according to claim 8, wherein the errors include positional errors, straightness errors, and/or angular errors.
